(19) United States
(12) Patent Application Publication
(10) Pub. No.: US 2007/0222748 A1
(43) Pub. Date: Sep. 27, 2007

(54) Computer input mobility station

(76) Inventor: Javier Maribona, Miami, FL (US)

Correspondence Address: LOTT & FRIEDLAND, P.A., P.O. BOX 141098, CORAL GABLES, FL, 33114-1098, US

(21) Appl. No.: 11/728,146

(22) Filed: Mar. 23, 2007

Related U.S. Application Data
(60) Provisional application No. 60/785,535, filed on Mar. 24, 2006.

(51) Int. Cl. G09G 5/00

(52) U.S. Cl. 345/156

(57) ABSTRACT

The present invention is a computer input mobility station comprised of a computer keyboard stand and a mouse mechanism that is integrated into the stand. This device allows for and encourages the use of the major muscles in the upper and lower body while simultaneously typing and using a computer mouse such that the risk of repetitive stress injuries associated with computer use is greatly reduced. This device uses the movements of the body that correspond to operating a keyboard to move the mouse pointer on a screen thereby enabling the user to simultaneously move a mouse, use a keyboard and enjoy a light form of exercise.

This application claims priority to corresponding U.S. Provisional Application No. 60/785,535, filed on Mar. 23, 2006, the disclosure and contents of which are expressly incorporated herein by reference.

### BACKGROUND OF THE INVENTION

Due to the widespread use of personal computers and the current functionality and design of computer keyboards, mouse devices and other peripheral devices, muscle and eye strain, temporary and permanent repetitive stress injuries and other associated ailments are frequently sustained by many people who rely on the operation of a computer to perform their daily tasks.

One of the problems associated with current keyboards and mouse devices is the lack of mobility afforded to the upper body while using a keyboard or mouse such that long hours are spent sitting in one position while making only slight, repetitive movements. Furthermore, current keyboards and mouse devices are designed to lie substantially on a horizontal surface such that a user must lean forward in an awkward position that causes lower and upper back strain and stiffness in the joints of the arms and hands.

Therefore, to reduce strain and injury from the use of a computer, improvements have been made to the ergonomic functionality and design of keyboards, mouse devices and other peripheral devices in order to improve the sitting posture and wrist posture of the user and to allow for a wider range of movements that better correlate with the body's natural resting positions. By increasing the use of the major muscles in the upper body during typing and using the mouse on the computer, the risk of repetitive stress injury and strain is greatly reduced. By allowing the upper body to rotate clockwise and counter-clockwise, forwards, backwards and side-to-side while typing, the major muscles will be in motion and continuously supplied with oxygen and blood thereby keeping them healthy.

For example, U.S. Publication No. 2006/0192415 to Steenson describes an adjustable tray that is mounted to the arm of a chair to provide a comfortably accessible work surface for supporting a computer mouse and other I/O devices. The length of the tray is adjusted by a series of slideable guides and stops. The tray includes one or more platforms that connect to rotatable joints such that the platforms may be tilted to a comfortable working angle. The tray provides the ability to bring peripheral devices of a computer into close proximity with a user who is in a sitting position in order to relieve the user of the strain in reaching for or leaning towards a typical desk surface.

In another example, U.S. Design Pat. D494,590 to Richter depicts a split ergonomic support with a keyboard in which a traditional keyboard, split into two sections, is integrated into the surface of a support whereby the support may effectively be split apart into two sections. The two sections remain connected at the top by a joint and spring.

In yet another example, U.S. Publication No. 2001/0035479 to Roebuck describes an upright ergonomic pointing device stand that is comprised of a top plate that is pivotally secured to a telescoping vertical support. The vertical support is attached to a weighted floor base and may be adjusted to different heights. A mouse platform or other device may be attached to the top plate. The stand is meant to achieve proper ergonomics and to free-up the work space normally required to operate the device.

A further example is U.S. Pat. No. 5,868,079 to Charny which describes an ergonomic stand with two shelves, each attached to a post, for supporting a computer monitor and keyboard. Each post is attached to a central base and are each independently extensible in order to adjust their vertical heights. The post attached to the keyboard shelf is pivotable about the base and the keyboard shelf is tiltable about its post. Additional auxiliary shelves may be directly attached, or attached by an extension or arm, to the stationary post supporting the computer monitor in order to support other devices.

Described in U.S. Pat. No. 5,915,659 to Scannell, Jr. is an adjustable ergonomic keyboard podium that includes a portable and collapsible tray for a computer keyboard, mouse pad and document holder, and a telescopic stand which may be adjusted to change the vertical height of the table. A slotted bracket attaches the table to the stand such that the horizontal position and angle of the table may be adjusted.

Described in U.S. Pat. No. 5,669,722 to Overthun et al. is a bifurcated computer keyboard including separated keyboard segments that are adjustably mounted, by using beveled protrusions, on inclined supports. The keyboard segments may be angled towards or away from each other by rotating their corresponding supports in a clockwise or counterclockwise direction. As the supports are rotated, the tilt of each keyboard segment also changes from a minimum to a maximum angle (in the range approx. 0° to 9° degrees). The utility of the keyboard is to allow the user to place segments of keys at ergonomically desired angles relative to the user.

Despite each of these improvements to the ergonomic design of a computer work surface, keyboard or mouse device, the primary stress still lies upon the hands and wrists when operating any of the above-described computer input-output (I/O) devices. Although the devices or work surface may be angled at a more comfortable and less strenuous position relative to the body, the muscles, joints and other tissues of the upper body barely move in comparison to the hands and wrists while operating the computer. Furthermore, the lower body is generally completely immobile.

Improvements have also been made to incorporate movement of the lower body in operating a computer thereby transferring some of the strain placed on the upper body, in particular the lower back, to the lower body where body weight is more suitably balanced. For example, some computer station designs require that the user stand while operating the computer. If standing and using the keyboard, the lower body can be mobilized with forwards, backwards and side-to-side movements of the hips and legs.

For example, U.S. Pat. No. 6,832,560 to Seiler et al. describes a work table that is attached to a floor base by a vertical column and includes a work surface capable of supporting a keyboard or any other device. The work surface is connected to the vertical column by a swivel arm. A rotary joint connects the work surface to the swivel arm so that the work surface may be tilted. Also, a rotary joint connects the swivel arm to the vertical column so that the height of the work surface may be adjusted from a standing to a sitting and to a lying down position. The work table provides the ability to quickly change working positions as frequently as ergonomically desired.

In another example, U.S. Pat. No. 5,841,426 to Dodson et al. describes a foot operated computer mouse that includes a base, and a ball that is fixed to the base for generating positional signals based upon a conventional x-y coordinate grid. A foot platform is attached to the top of the ball and may be wobbled, or simultaneously rotated and inclined when pressure is applied to the platform by the user's foot. Forward or lateral motion of the foot moves the mouse cursor along a computer screen. Wobbling the foot causes the platform to make contact with inclined switch operators at various locations on the base that operate like conventional mouse buttons when depressed. The work table provides an ergonomic mouse device and the second hand normally used to operate a mouse is left free.

Both of these described improvements, as well as others known in the art, allow the user to stand while operating a computer and/or to use the muscles and joints of the ankle and foot to operate a mouse device. However, none of these improvements encourage or increase the use of the multiple muscles and joints of the body while operating a computer. Rather, the majority of the body remains immobile while the greatest stress is placed on the hands and wrists or feet and ankles of the body for operating the computer.

Therefore, it an object of this invention to provide a computer input mobility station that encourages and increases the use of the major muscles in the upper and lower body during typing and using the mouse device with a computer.

It is another object of this invention to provide a computer input mobility station that may be used with any type of keyboard, mouse device or other peripheral device that is used for operating a computer.

It is a further object of this invention to provide a computer keyboard stand that has an integrated mouse mechanism within the bottom portion of the stand such that the mouse mechanism functions by moving the stand in a desired direction.

### SUMMARY OF THE INVENTION

The present invention solves significant problems in the art related to the ergonomic design of and improvements to the usage of a computer and the performance of other desktop tasks.

The present invention consists of a computer keyboard stand comprised of a tray that may, in some embodiments, effectively be split into two tray sections by attachment to a Y-plate such that it may be used with a split computer keyboard. The tray is connected by way of a vertical, upright adjustable bar to a pivot joint at the bottom of the stand. The pivot joint may include a computer mouse mechanism such that while the mouse function is enabled, any movement of the tray assembly causes the mouse pointer or cursor on a computer screen to move in a corresponding direction. A junction box is used to electrically connect the keyboard and mouse assembly to a computer.

The Y-plate is attached to the vertical, upright adjustable bar such that it may be tilted forwards and backwards in relation to the bar. The two side arms of the Y-plate are each attached to a corresponding tray section in order that the stand can accommodate a traditional or split keyboard or support more than one peripheral device or object. The side arms are adjustable such that a split keyboard may be separated at various widths in order that the user may operate the keyboard from a variety of planes of motion. Furthermore, each attachment point between the Y-plate and tray section is adjustable such that the tray section may be tilted or rotated about the point of attachment in order that each tray section may be placed at various positions ranging from horizontal upright to vertical to horizontal upside down.

The height of the vertical bar may be adjusted and a turntable attachment may be provided at the top of the bar thereby allowing the tray assembly to have a 360° range of motion about the bar.

As stated above, the pivot joint connecting the main adjustment bar to the bottom of the stand may include a mouse mechanism that consists of an assembly unit, ball and socket or spring combination located within the pivot joint. In order to operate the mouse mechanism, the tray assembly is pivoted at the joint such that the pointer or cursor on the computer screen moves in a direction corresponding to the movement of the tray assembly. Means are provided to enable and disable the mouse functionality of the stand such that when it is disabled, any movement of the tray assembly will not translate into movement of the cursor on the screen. This allows a user to alternatively use a traditional mouse in connection with the keyboard stand.

The disclosed stand can function as a stand-alone unit, a desktop device or can be attached to exercise equipment.

### BRIEF DESCRIPTION OF THE DRAWINGS

FIG. 1A is a side view of a computer input mobility station with a split tray configuration whereby the integrated mouse mechanism is a ball-and-socket mechanism.

FIG. 1B is a side view of a computer input mobility station with a split tray configuration whereby the integrated mouse mechanism is a combination of a ball-and-socket and spring.

FIG. 2A is a top view of a left tray section of the computer input mobility station shown in FIGS. 1A and 1B.

FIG. 2B is a top view of a right tray section of the computer input mobility station shown in FIGS. 1A and 1B.

FIG. 3 is a bottom view of a tray section of the computer input mobility station shown in FIGS. 1A and 1B.

FIG. 4A is a side view of a tray assembly of the computer input mobility station shown in FIGS. 1A and 1B in a horizontal upright configuration.

FIG. 4B is a side view of a tray assembly of the computer input mobility station shown in FIGS. 1A and 1B in a vertical configuration.

FIG. 4C is a side view of a tray assembly of the computer input mobility station shown in FIGS. 1A and 1B in a horizontal upside down configuration.

FIG. 5A is a side view of a turntable mechanism of the computer input mobility station shown in FIGS. 1A and 1B.

FIG. 5B is a top view of a turntable mechanism of the computer input mobility station shown in FIGS. 1A and 1B.

FIG. 6A is a side view of bottom half of a computer input mobility station whereby the stabilizing lock bars are in an unlocked position.

FIG. 6B is a side view of the bottom half of a computer input mobility station whereby the lock bars shown in FIG. 6A are in a locked position.

FIG. 7 is a side view of a mouse mechanism of the computer input mobility station shown in FIG. 1B.

FIG. 8 is a side view of a mouse mechanism and junction box of the computer input mobility station shown in FIG. 1A.

FIG. 9 is a wire schematic diagram of the computer input mobility station shown in FIG. 1A.

FIG. 10A is a side view of the tray assembly with an attached optional tray of a computer input mobility station in a horizontal upright configuration.

FIG. 10B is a side view of the tray assembly with an attached optional tray of a computer input mobility station in a vertical configuration.

FIG. 11A is a side view of a computer input mobility station with a single tray configuration whereby the integrated mouse mechanism is a ball-and-socket mechanism.

FIG. 11B is a side view of a computer input mobility station with a single tray configuration whereby the integrated mouse mechanism is a combination of a ball-and-socket and spring.

### DETAILED DESCRIPTION OF THE INVENTION

The present invention is a computer input mobility station that is comprised of a computer keyboard stand and a mouse mechanism that is integrated into the stand. While the invention is susceptible of several embodiments, there is shown in the drawings specific embodiments thereof, with the understanding that the present disclosure is to be considered as an exemplification of the invention and is not intended to limit the invention to the specific embodiments shown.

The present invention is not meant to require a lot of upper body force to initiate and continue the various directional changes but rather, it is meant to provide the ability to move the upper torso and arms in a wide range of movements in order to increase blood flow through the extremities and to keep the spine and joints of the upper body flexible and healthy while operating a computer. The present invention can function as a stand-alone unit, desktop device or can be attached to various exercise equipment. Furthermore, due to the flexible configuration of the present invention, users who suffer from physical or mental handicap or other such limitations may more easily operate a computer.

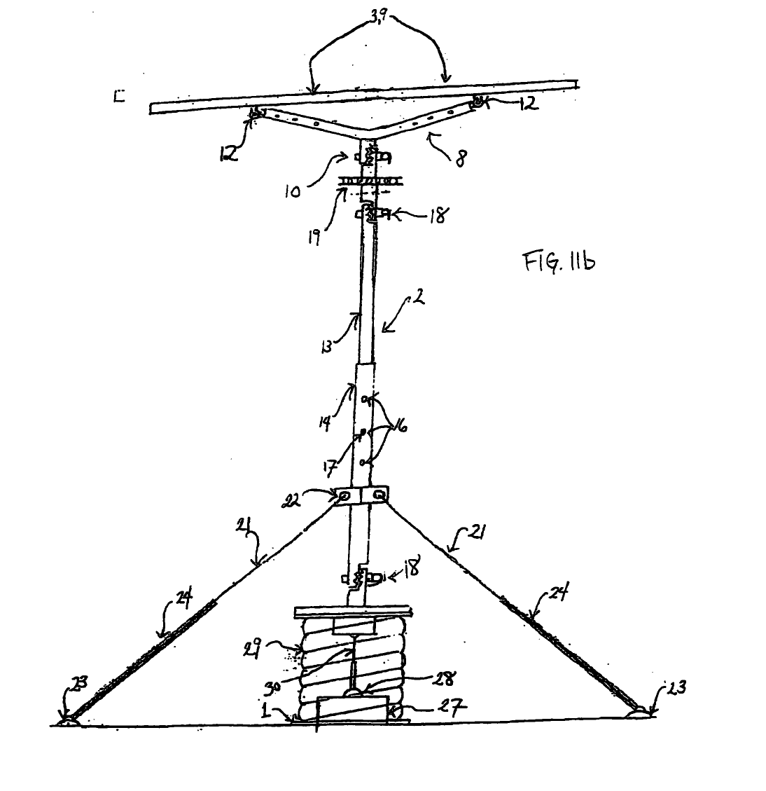

Referring to FIGS. 11A and 11B, the computer keyboard stand is comprised of a base plate 1 that rests atop a floor, desktop or other substantially flat surface, a vertical, upright adjustment bar 2 and a single tray 3 that is mounted onto the adjustment bar. Alternatively, the computer keyboard stand may include other means in place of a base plate, such as a clamp (not shown), for mechanically attaching the stand to a non-planar surface such as the side of a desktop or exercising equipment.

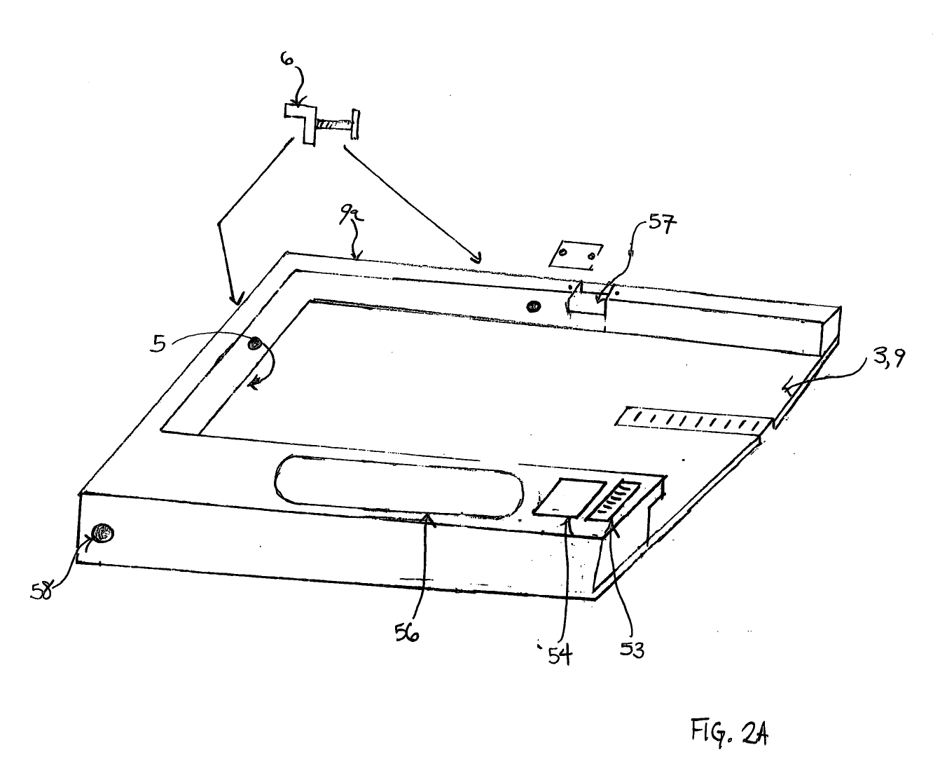

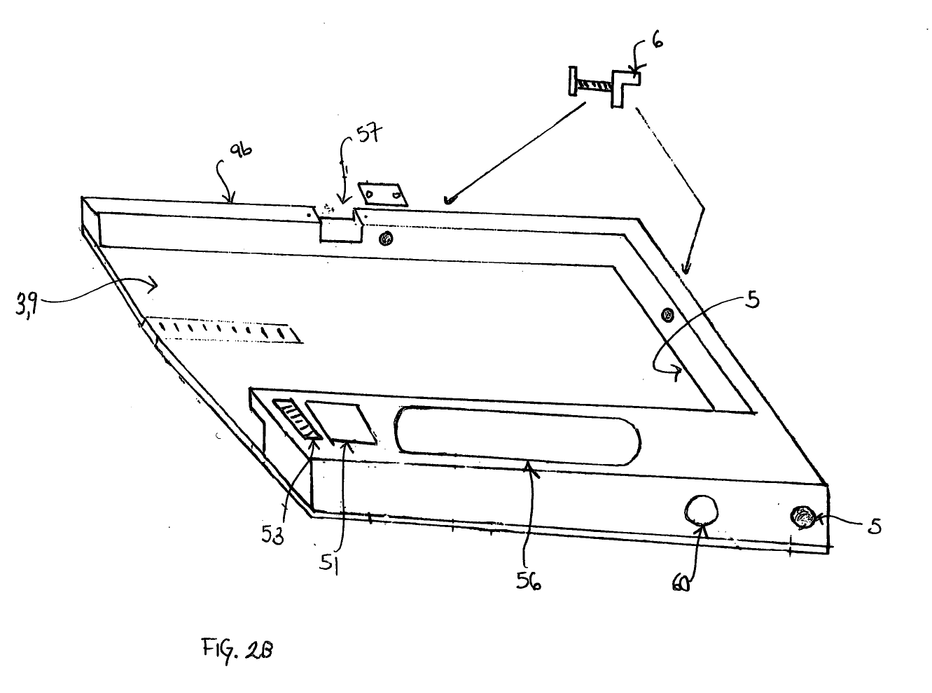

A computer keyboard or any other device, wired or wireless, may be placed on top of the tray. Referring to FIGS. 2A and 2B, the tray 3 is substantially flat and may include a recessed portion 5 that is sized to fit a keyboard or other device in order to better stabilize the device on the tray. In addition, the keyboard or other device may be mechanically secured to the tray using a variety of means including a suitable adhesive (not shown) and/or one or more screws or pins 6. In order that the user may tilt the tray to a desired, comfortable working angle, the computer keyboard tray is mounted to the vertical adjustment bar 2 by a rotating joint 10 such that the tray may be tilted or pivoted forwards and backwards upon the main adjustment bar 2.

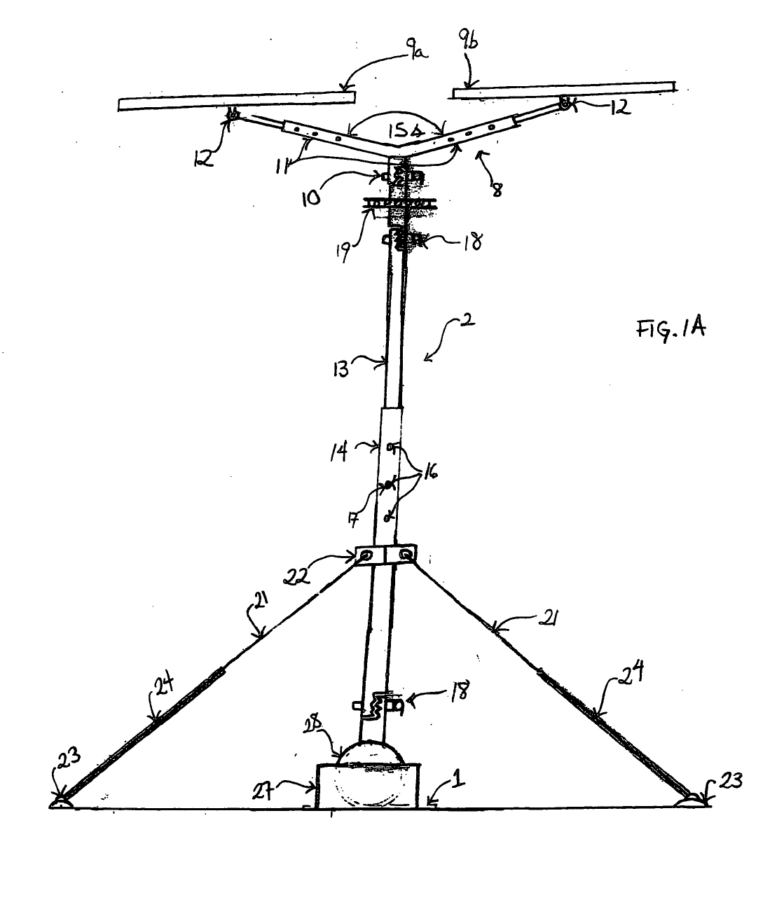

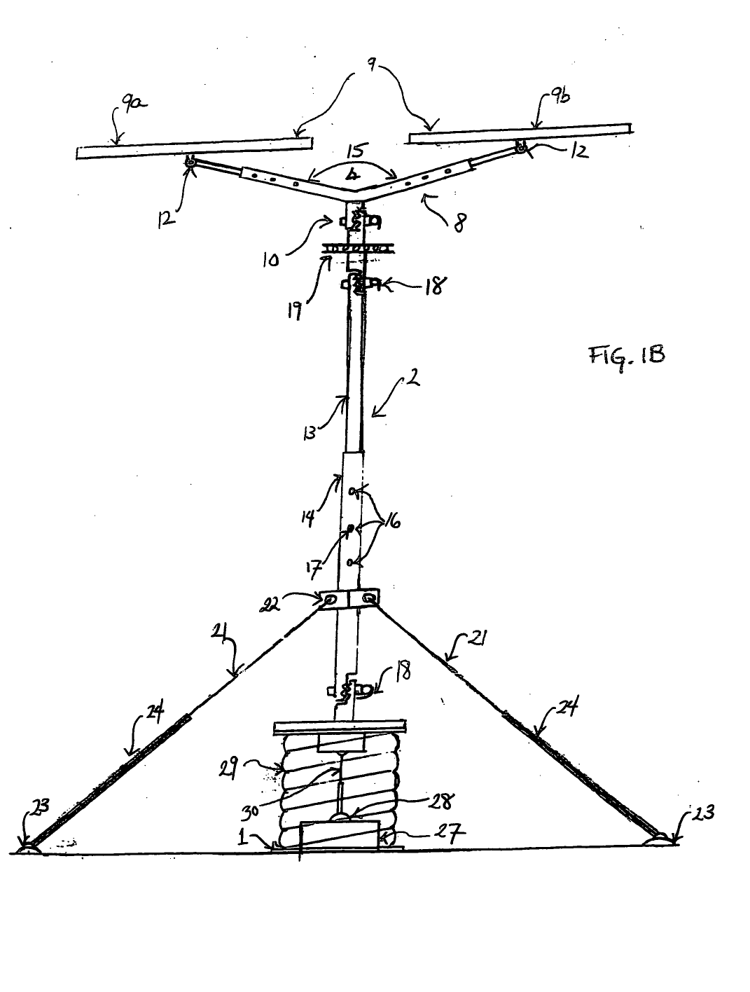

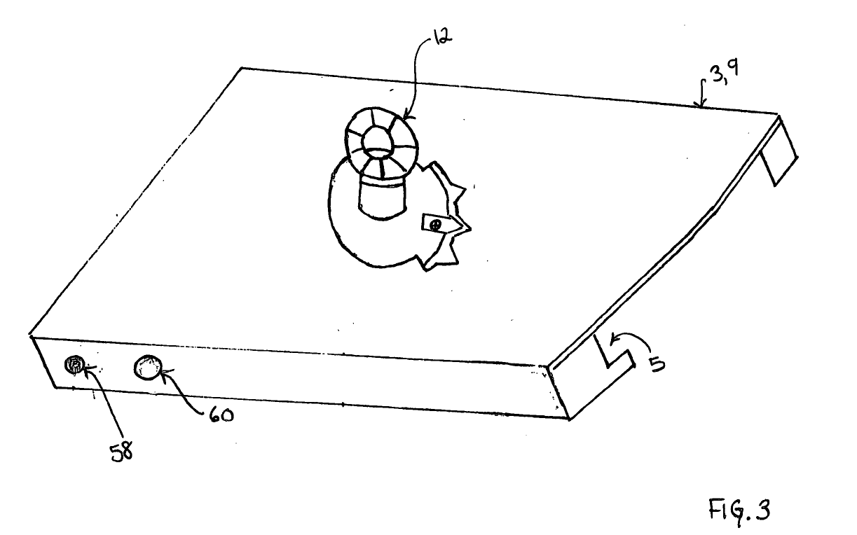

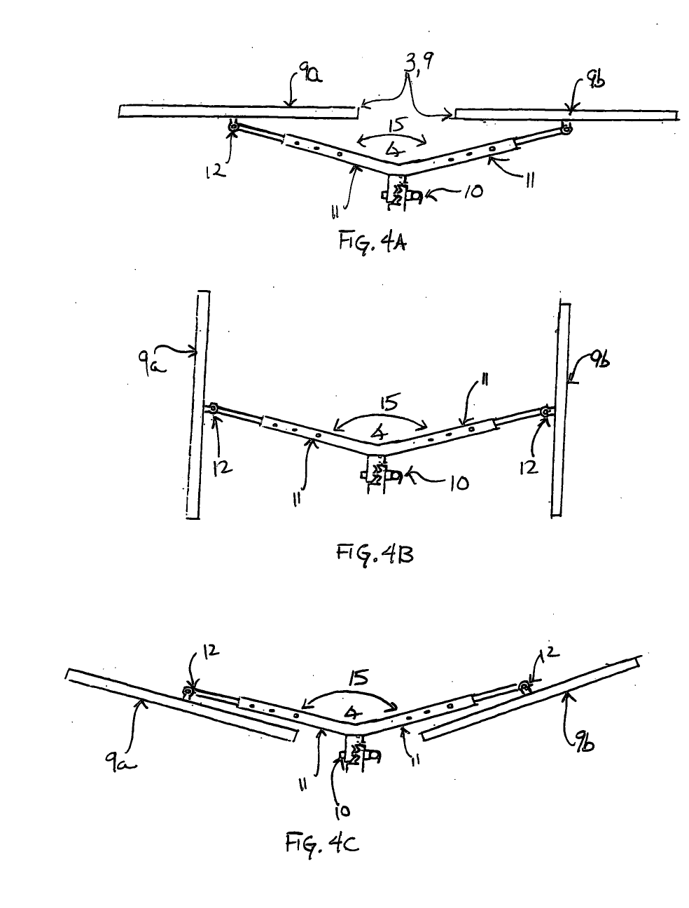

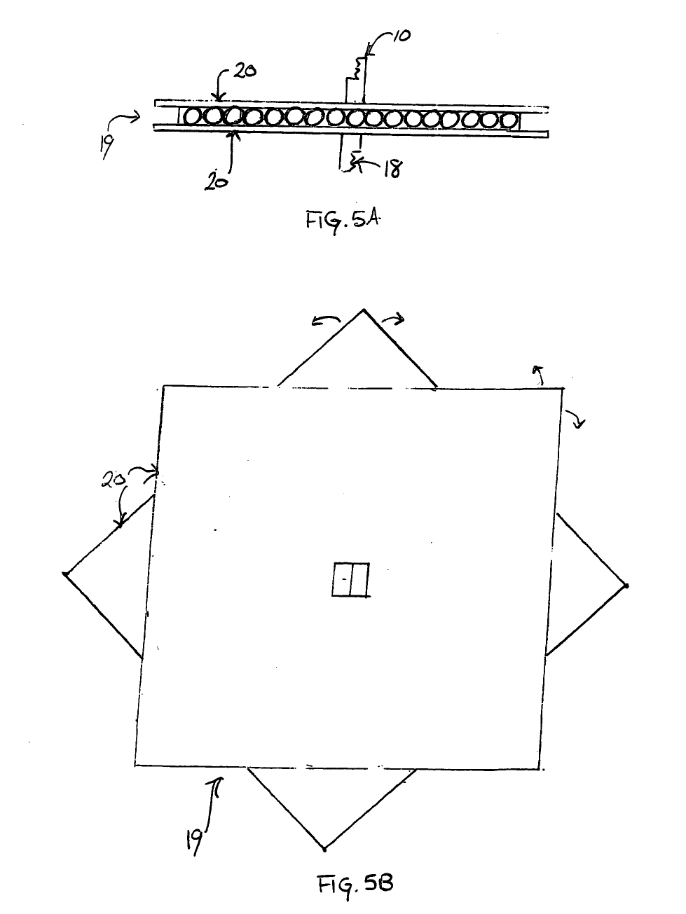

Referring to FIGS. 1A and 1B, in some embodiments, the single tray 3 may effectively be split into two or more tray sections 9, for example sections 9a and 9b shown in FIGS. 1A and 1B, for accommodating a split keyboard or multiple peripheral devices or objects. Each tray section may be attached to a Y-plate 8 or other split support device that has two or more telescoping extensions 11 that may pivot in relation to the stand. Instead of directly attaching a single tray 3 to the vertical adjustment bar, the Y-plate is attached directly to the vertical adjustment bar at the rotating joint 10 and the one or more tray sections 9 are each attached to an extension 11 of the Y-plate 8 or other split supporting device. As shown in detail in FIG. 3, on the underside of each tray section is a rotating coupler 12 for attaching the tray section to an extension of the Y-plate. As shown in FIGS. 4A-4C, the rotating coupler 12 allows the user to tilt each tray section 9, independently of the other tray sections, to various positions ranging from horizontal upright (FIG. 4A) to vertical (FIG. 4B) to horizontal upside down (FIG. 4C).

Referring back to FIG. 1A, the multiple extensions 11 of the Y-plate or other support device also allow the user to alter the height of each tray section independently of the other tray sections and to widen or lessen the distance between each tray section by telescoping extensions 11 in order to increase or decrease the distance 15 between them. Thus, by using a support device having two or more extensions, users can easily accommodate the configuration of the computer stand to their individual preferences best-suited for their preferred comfort position and body type. Furthermore, the extensions provide the user with the alternative of using the disclosed computer stand in conjunction with the current ergonomically-improved split keyboard designs rather than being restricted to using a traditional keyboard.

The vertical, upright adjustment bar 2 is adjustable such that the vertical height of the stand may be changed thereby allowing the user to stand, sit or recline while operating the computer. In one embodiment, the bar is comprised of two telescoping bars whereby a first bar 13 of smaller diameter is sized to slide within a second bar 14 of larger diameter. The larger, outer bar has one or more vertically-spaced holes 16 along its outer surface that correspond in size to a push button 17 that is on the outer surface of the inner, smaller bar. As the user slides the inner bar 13 within the outer bar 14, the push button 17 protrudes into the hole 16 [as shown in FIGS. 1A and 1B] as it is exposed to the hole, thereby securing the height of the bar 2 into place. To release the push button from the hole, the user pushes the button inwards towards the center of the stand. Depending on the desired height of the bar, the user slides the inner bar to cause the push button to correspond with the hole that will secure the bar to the desired height.

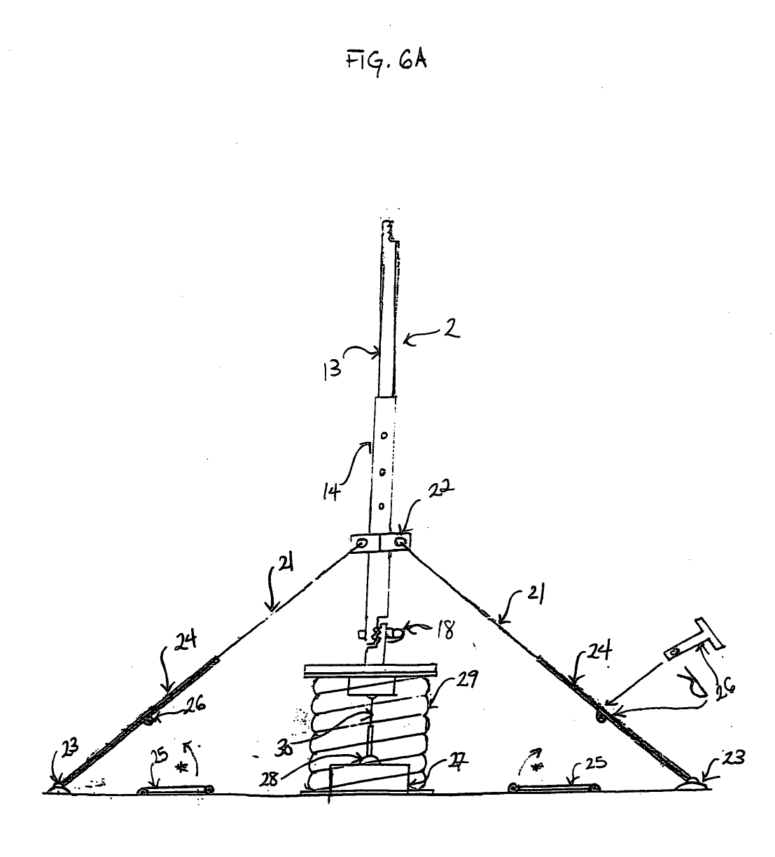

In addition, in certain embodiments, the adjustment bar 2 may have one or more additional rotating joints 18 along its length in order that segments of the bar can be swiveled or that the entire bar may be collapsed to a smaller dimension when the computer stand is not in use (not shown). A turntable mechanism 19, commonly referred to as a “Lazy Susan” in which two flat plates 20 rotate with respect to one another [as shown in detail in FIGS. 5A and 5B], can also be attached somewhere along the length of the bar such that the tray assembly has a 360° degree range of motion about the bar.

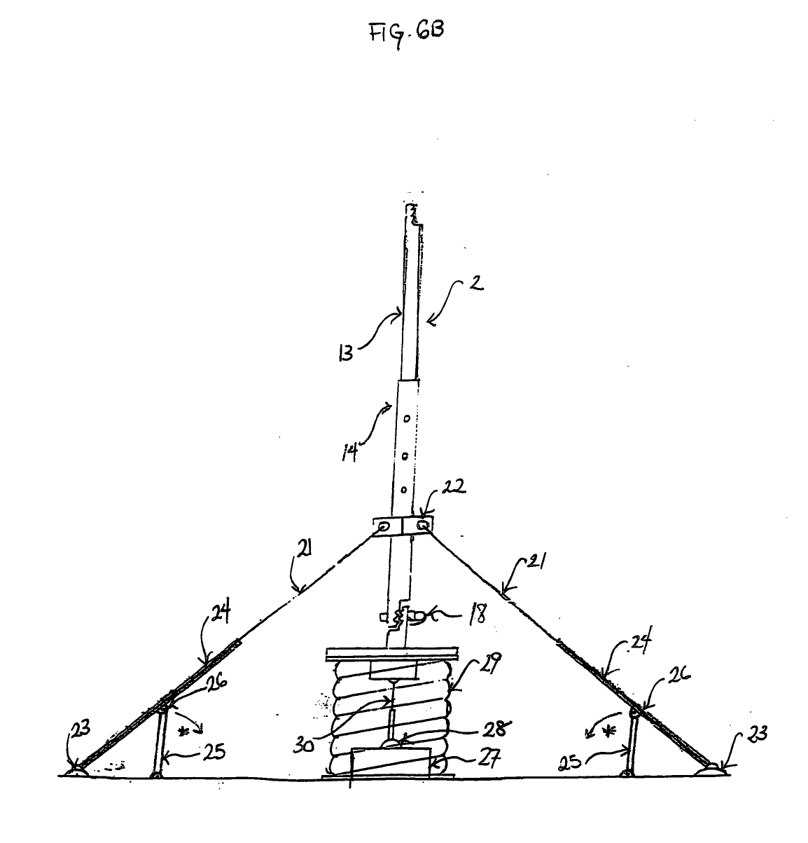

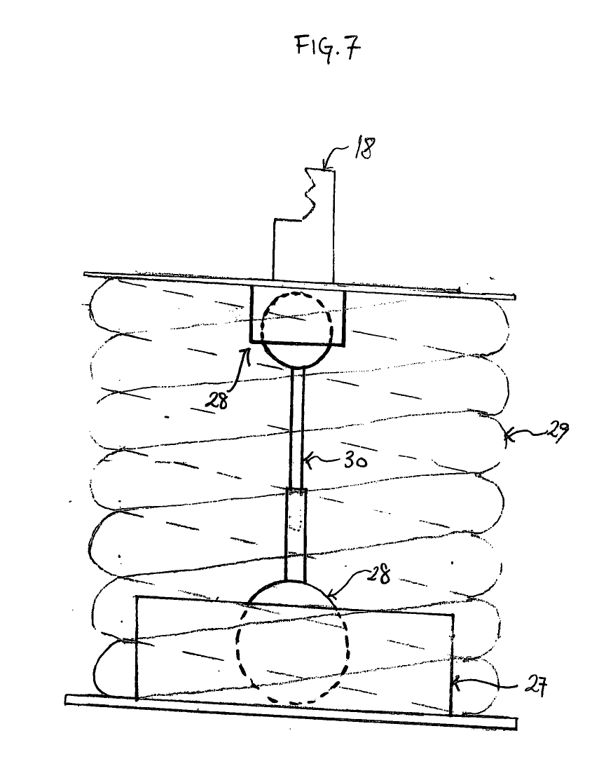

In order that the adjustment bar 2 is stabilized in an upright position with respect to the floor or other surface, the bar is inserted through a collar 22 in the shape of a triangle, square, circle or other geometry, and two or more spokes or stilts 21 originate from the collar 22 and radiate to the floor. At the radiating ends of the spokes or stilts 21 are pads 23 which rest horizontally onto the floor. Thus, the spokes or stilts serve to prop up and support the vertical, upright adjustment bar. In an alternative embodiment, the radiating ends of the spokes or stilts are attached to the base plate rather than resting directly on the floor surface for enhanced stability (not shown). In yet another embodiment, the spokes or stilts may have pistons 24 along their lengths such that the length of the spokes or stilts 21 will be compressed or lengthened during movement of the trays on the base. When the adjustment bar 2 is moved forward, backward or side to side, the increased or decreased length of the spokes or stilts 21 is accommodated by the ball and socket attachments at collar 22 as further described below. As shown in FIGS. 6A and 6B, once the pistons 24 are at the position desired by the user, the bar 2 can be locked into place [FIG. 6B] by attaching lock bars 25, located on the base plate, to the pistons using pins and clips 26. To unlock the lock bars so that the length of the pistons may be altered, the lock bars 25 are released from pins and clips 26 on pistons 24 [FIG. 6A].

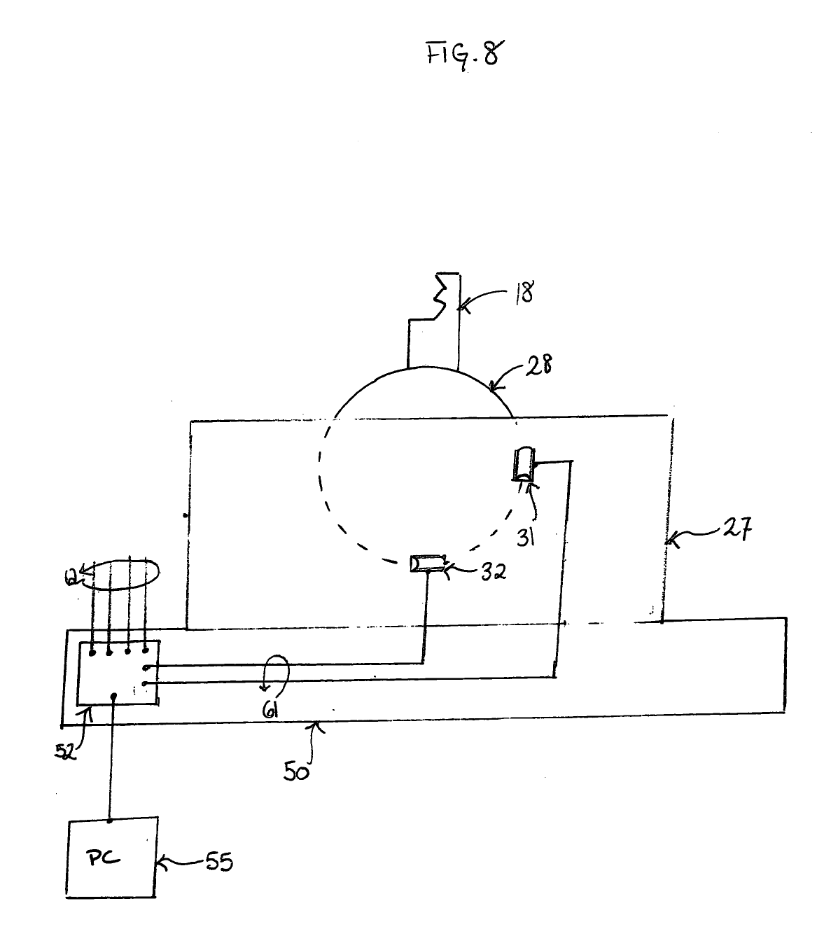

The pistons 24, as just described, also function to assist in the operation of the input-output (I/O) mouse embodiment of the present invention. As shown in FIGS. 1A and 1B, a motion sensing unit 27, consisting of a combination of ball-and-socket 28 and/or spring models 29, piston 30 [as shown in detail in FIG. 7] or other mechanisms, is integrated into the bottom of the stand. In order to operate the mouse function of the stand, the user tilts or moves the tray assembly 3. Forwards, backwards and side-to-side motion of the tray assembly 3 is allowed by the associated combination of ball-and-socket 28 and/or spring models 29, piston 30 or other mechanisms and the flexibility of the pistons 24 along the supporting spokes or stilts 21.

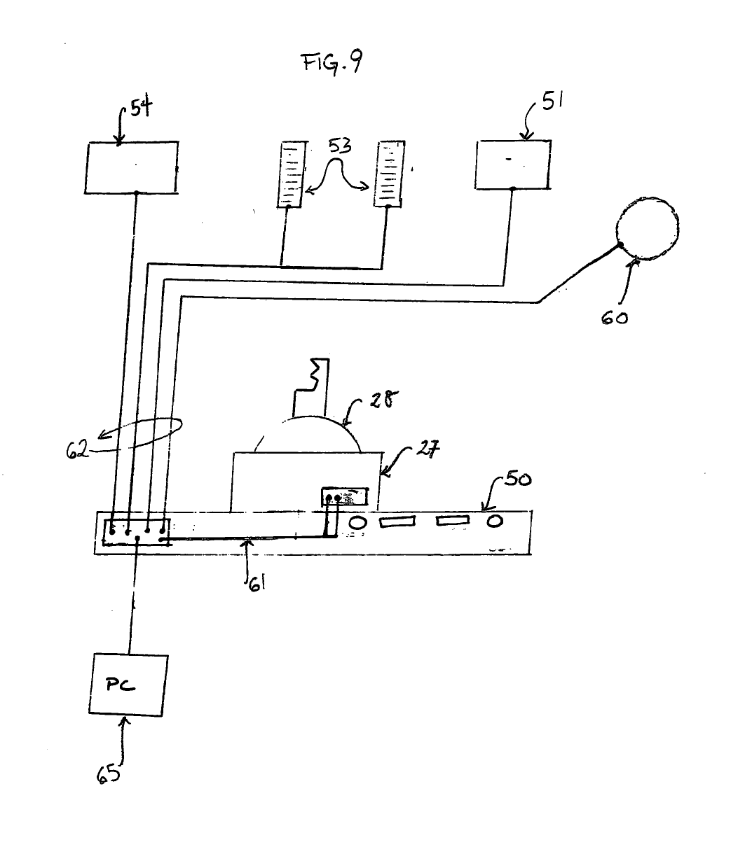

As shown in FIG. 8, this motion is registered by a motion sensing unit 27 that is located proximate to the base plate and junction box 50. The motion assembly unit 27 contains motion rollers or sensors such as 31 and 32. In the embodiment shown, roller/sensor 31 detects movement of the ball-and-socket 28 in the horizontal direction and roller/sensor 32 detects movement in the vertical direction. As shown in FIGS. 8 and 9, these sensors or rollers translate the motion into movement of the mouse cursor or pointer on the computer screen through connection 61 to a translation unit 52 that is found on junction box 50.

Referring back to FIGS. 2A and 2B, mouse click buttons that are normally found on traditional mouse devices for selecting objects on a computer screen are instead located on the tray 3 and are connected by wires 62 to the computer 65 via a junction box 50 [as shown in the wire schematic diagrams of FIGS. 8 and 9]. The right 51 and left 54 click buttons, one or more scroll mechanisms 53 and one or more ergonomic palm pads 56, composed of neoprene, ergonomic gel, or other suitable material, are examples of the types of functionality that can be included into the surface of the tray 3. Wired connections 61 between the motion assembly unit 27 and keyboard (not shown) to the computer 65 are also via a junction box 50.

The mouse functionality of the stand may be activated (or enabled) and deactivated (or disabled) to allow the user the option of using a traditional mouse device or to prevent inadvertent motions of the stand to effect the cause unwanted modifications on the computer screen. The mouse is enabled or disabled pushing a button 60 that is positioned on the tray unit 3 [as shown in FIG. 2B]. While the mouse is in an enabled mode, any motion of the tray assembly, while typing or not typing, will cause the mouse pointer to move on the screen according to the movement of the assembly. Also when enabled, the mouse buttons on the tray function in normal mouse operation. When disabled, any movement of the motion assembly will not translate into motion of the mouse pointer on the screen and the mouse button on the tray will also not function. This mode ensures that the mouse pointer will not move on the screen while the user is typing or moving the assembly. It is envisioned that on certain embodiments of the disclosed invention, the mouse function may be enabled or disabled automatically depending, for example, on actions taken by the user or by the software being used. For example, the mouse function may be automatically disabled if a keyboard press is detected.

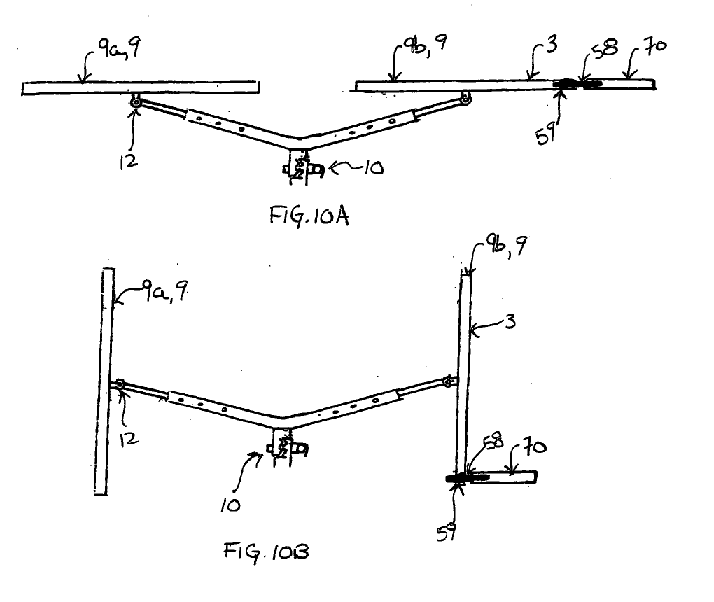

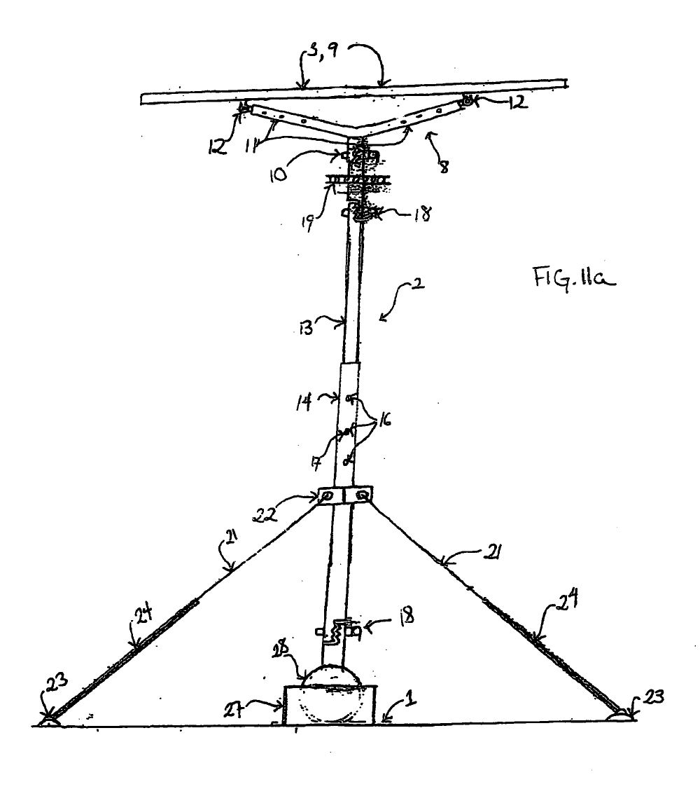

As depicted in FIGS. 10A and 10B, in order to accommodate a traditional mouse device or to attach any other additional I/O or peripheral device, an optional tray 70 can be attached to the keyboard tray 3 via threaded eyelets 58 and bolts 59. In addition, referring back to FIGS. 2A and 2B, the tray 3 or one or more tray sections 9 can include a wire-pass groove 57 in order to conveniently hide and route the wires that originate from the traditional mouse, keyboard and other I/O or peripheral devices along the tray 3 and 9 and to the junction box 50.

As is apparent to one of skill in the art, departures may be made from such details of the present invention without departing from the spirit and scope of the present invention. It is to be understood that the present invention is not limited to the embodiments described above, but encompasses any and all embodiments within the scope of the following claims.

What is claimed is:

1. A computer input mobility station comprising:
a support member having a proximate and distal end;
a tray attached to said proximate end of said support member;
a computer input device pivotally attached to said distal end of said support member;
wherein said computer input device is coupled to a computer;
wherein movement of said tray results in the pivoting motion of said support member relative to said computer input device; and
wherein said pivoting motion is detected by said computer input device and results in the transmission of an input signal to said computer.

2. The computer mobility station of claim 1 wherein said tray is pivotally attached to said proximate end of said support member.

3. The computer input mobility station of claim 2 wherein said pivotal attachment between said tray and said proximate end of said support member comprises a rotating joint.

4. The computer mobility station of claim 1 wherein said tray is attached to said support member by means that permit it to translate and rotate relative to said support member.

5. The computer mobility station of claim 1 wherein said support member has an adjustable length.

6. The computer input mobility station of claim 5 wherein said support member comprises a telescoping arrangement having a plurality of nested cylindrical elements wherein said length is adjusted by slidingly moving said cylindrical elements in relation to each other.

7. The computer input mobility station of claim 6 wherein said sliding movement is aided by a hydraulic or pneumatic piston.

8. The computer input mobility station of claim 1 wherein said pivotal attachment between said computer input device and said distal end of said support member comprises a ball-and-socket joint.

9. The computer input mobility station of claim 1 wherein said pivotal attachment between said computer input device and said distal end of said support member comprises a spring and piston.

10. The computer input mobility station of claim 1 wherein said tray includes a turntable.

11. The computer input mobility station of claim 1 wherein said computer input device includes means to selectively couple and de-couple it from said computer.

12. The computer input mobility station of claim 11 wherein said coupling and de-coupling means comprise a motion sensor.

13. The computer input mobility station of claim 12 wherein the motion sensor is electrically coupled to the computer via a junction box.

14. The computer input mobility station of claim 11 wherein said coupling and de-coupling means comprises a user selectable switch.

15. The computer input mobility station of claim 1 wherein said computer input device is selected from the group comprised of mice, buttons, switches, scroll-wheels, trackballs, keyboards, tablets, digitizers, touchpads and combinations thereof.

16. The computer input mobility station of claim 1 wherein said tray is adapted to receive a second computer input device.

17. The computer input mobility station of claim 16 wherein said second computer input device is selected from the group comprised of mice, buttons, switches, scroll-wheels, trackballs, keyboards, tablets, digitizers, touchpads and combinations thereof.

18. The computer input mobility station of claim 1 wherein said tray is split into a plurality of sections.

19. The computer input mobility station of claim 18 wherein said tray sections include means to rotate, pivot and translate them relative to each other.
